(19) United States
(12) Patent Application Publication
(10) Pub. No.: US 2021/0403748 A1
(43) Pub. Date: Dec. 30, 2021

(54) Impervious Coatings for Making Metal, Metal Oxide, and Silicon Oxide Surfaces Resistant to Graffiti

(71) Applicant: 3M INNOVATIVE PROPERTIES COMPANY, St. Paul, MN (US)

(72) Inventors: Dennis E. Vogel, Lake Elmo, MN (US); Kim M. Vogel, Lake Elmo, MN (US); Mark E. Mueller, Marine-on-the-St. Croix, MN (US); Bruce E. Tait, Woodbury, MN (US); Karl J. Manske, St. Anthony, MN (US); George W. Griesgraber, Eagan, MN (US); John C. Clark, Lake Elmo, MN (US); James R. Imbertson, Maplewood, MN (US)

(21) Appl. No.: 17/290,387

(22) PCT Filed: Dec. 11, 2019
(86) PCT No.: PCT/IB2019/060655

§ 371 Date: Apr. 30, 2021

Related U.S. Application Data
(60) Provisional application No. 62/781,262, filed on Dec. 18, 2018.

(51) Int. Cl. C09D 171/00; C09D 5/00; C08G 65/22; C08G 65/335

(52) U.S. Cl. CPC C09D 171/00; C08G 65/3355; C08G 65/226; C09D 5/00

(57) ABSTRACT

A graffiti-repellant article comprising a substrate having a surface comprising metal, metal oxide, silicon oxide, or combinations thereof; and an impervious coating disposed on said surface, wherein the impervious coating comprises a fluorinated polymer bonded to the surface layer; wherein the fluorinated polymer has the following general formula (I) where n=6 to 120.

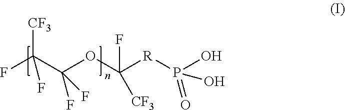

### FIELD

The present disclosure relates to impervious coatings for substrates having metal, metal oxide, and silicon oxide surfaces, which coating can make the substrate resistant to graffiti.

### BACKGROUND

Objects having metal, metal oxides, or silicon oxide surfaces can be marred or defaced by paint, ink, or other fluids carrying dyes, pigments, and other colorants. Objects having these types of surfaces are numerous and include bridges, cars, trucks, elevators, escalators, lockers, doors, tables, signs, display screens, and many other items. The marring or defacement may be intentional or may be accidental. In either case, it would be useful to make such surfaces impervious to fluids.

### SUMMARY

Generally, the present application relates to impervious coatings for use on substrates having a metal, metal oxide, and/or silicon oxide surface to create an article that repels inks, paints, and other fluids.

Some embodiments provide an article comprising a substrate having a surface comprising metal, metal oxide, silicon oxide, or combinations thereof; and an impervious coating disposed on said surface, wherein the impervious coating comprises a fluorinated polymer bonded to the surface layer; wherein the fluorinated polymer has the following general formula (I)

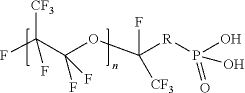

where n=6 to 120.

The above summary of the present disclosure is not intended to describe each embodiment of the present disclosure. The details of one or more embodiments of the disclosure are also set forth in the description below. Other features, objects, and advantages of the disclosure will be apparent from the description and from the claims.

### BRIEF DESCRIPTION OF DRAWINGS

The disclosure may be more completely understood, and those having ordinary skill in the art to which the subject invention relates will more readily understand how to make and use the subject invention, in consideration of the following detailed description of various exemplary embodiments of the disclosure in connection with the accompanying drawings, in which:

FIG. 1 is a photograph showing aluminum coupons illustrating the performance of the impervious coatings of the present invention.

FIG. 2 is a photograph showing aluminum coupons illustrating the performance of comparative coating.

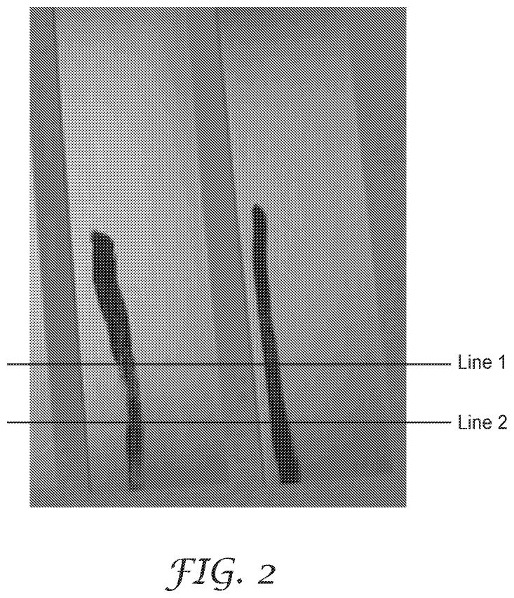

### DETAILED DESCRIPTION

As used herein, it should be understood that when a layer (or coating) is said to be “formed on” or “disposed on” another layer (or substrate), the layers are understood to be generally parallel to one another, but there may be (although there are not necessarily) intervening layers formed or disposed between those layers. In contrast, “disposed directly on” or “formed directly on” means layers (or a layer and a substrate) are necessarily in direct contact with one another, with no intervening layers (other than possibly a native oxide layer).

As used herein, the term “impervious” means not allowing fluid to pass through.

As used herein, the term “graffiti” means a mark made on a surface using paint, ink, or other fluids carrying dyes, pigments, or other colorants. Such marks may be created with a variety of tools such as, but not limited to, spray paint cans, marker pens, brushes, and sponges.

As used herein, the term “monolayer” means a single, closely packed layer of atoms or molecules.

As used herein, the term “surface layer” means a layer of material on the substrate that is different from the substrate material adjacent to the surface layer.

As used herein, the term “surface” means one or both of (a) the portion of a substrate exposed to the atmosphere and (b) a surface layer.

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification, embodiments, and claims are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

In embodiments with a flexible substrate, the substrate may comprise a polymer substrate. Any polymeric material suitable for use as a flexible substrate may be used. Examples of suitable materials include PET, polypropylene, polyethylene, nylon, and polyimide.

The substrate may have smooth or textured surface. Smooth means an R(a) of at most 0.1 microns and textured means an R(a) of at least 10 microns, wherein R(a) is defined as the arithmetical average value of all absolute distances (peaks and valleys) of the roughness profile from the center line within the measuring length. A rough surface may be a property of the polymeric material comprising the substrate, e.g., created by embossing, microreplication, electroforming, or additives in the polymeric material, or it may be created by the addition of materials to the surface of the polymeric material, e.g., microscopic particles such as microscopic beads embedded in the surface of the polymeric material. A variety of structures could be used to form a textured surface.

In some embodiments, major surfaces of the substrate may be subjected to one or more surface preparation processes such as cleaning with water or a chemical solvent, heat treatment, polishing, other surface preparation process, or combinations thereof.

In some embodiments, the flexible substrate has a surface layer deposited on all or a portion of one or both major surfaces.

In some embodiments, the surface comprises metal, metal oxide, silicon oxide, or a combination thereof. Suitable metals include aluminum, titanium, tungsten, nickel, copper, tin, chromium, chromium containing alloys, and combinations thereof. Suitable metal oxides include aluminum oxide (Al₂O₃), chromium oxide (Cr₂O₃), nickel oxides (NiO, Ni₂O₃), titanium oxide (TiO₂), tungsten oxides (WO₂, WO₃, W₂O₃), copper oxide (CuO), tin oxide (SnO₂), and indium tin oxide (ITO) and combinations thereof. In some embodiments, the surface comprises silicon oxide (SiO₂) alone or in combination with a metal or metal oxide.

If the surface is a surface layer, it may be deposited by any suitable method including sputtering, vapor coating, or atomic layer deposition (ALD).

In some embodiments, the surface (typically a surface layer in this case) may comprise sub-layers of different or the same materials. For example, metal may be sputtered in a series of sub-layers. In some embodiments, SiO₂ is deposited by atomic layer deposition. In some embodiments a surface having both a metal and metal oxide is formed, e.g., by depositing a metal layer and allowing the metal atoms at the surface of such metal layer to oxidize. In this manner, a surface comprising a metal layer with an oxide layer at the surface having a thickness of at least a monolayer may be formed.

A surface layer may be any suitable thickness. Preferred thicknesses for the surface layer is from a monolayer to 15 micron or from a monolayer to 20 microns.

In some embodiments, an impervious coating is deposited on all or a portion of the substrate surface. In some embodiments, the impervious coating causes inks or dyes applied to a coated surface to form beads.

In some embodiments, the impervious coating includes (or is formed of) a fluorinated polymer that bonds to the surface layer of the substrate. The bond may be achieved through coordination attachment, covalent attachment, intermolecular forces such as van der Waals, dipole-dipole, ion dipole, hydrogen bonding, or a combination thereof. In some embodiments, the bond may be formed between the fluorinated polymer and one or more active sites on the surface of the substrate. In some embodiments, the impervious coating does not wash off with organic solvents which demonstrates it is chemically bonded to the surface. Preferably the surface is cleaned before the impervious coating is applied, to ensure maximum bonding.

In some embodiments, the fluorinated polymer in the impervious coating has the following general formula (I):

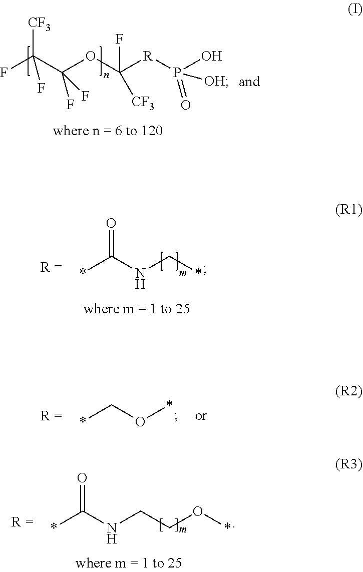

In some embodiments, the fluorinated polymer may include those fluorinated polymers in which n ranges from 36 to 42. In some embodiments, the fluorinated polymer may include those fluorinated polymers having a number average molecular weight (Mₙ) of 1,000-20,000 or 6,000-7,000 daltons.

In some embodiments, the fluorinated polymer impervious coatings are phosphorus acids of polymers derived from hexafluoropropylene oxide and are self-assembling materials.

Self-assembling materials, as their name implies, spontaneously form a structure (e.g., micelle or monolayer) when they contact another substance. Monolayer formation is particularly useful when it occurs on the surface of a solid substrate (e.g., a layer of metal). If a monolayer is formed from a material that imparts a low surface energy to a surface of a substrate, it can make the surface impervious. Typical self-assembling materials consist of a polar head group attached to a hydrophobic tail. Boardman et al. (U.S. Pat. No. 6,824,882) describe the use of fluorinated phosphonic acids as self-assembling materials. The phosphonic acid head group binds to the metal surface while the long alkyl chains align the molecules in a self-assembly and the tail end of the molecule comes to the surface exposing only the fluorochemical portion of the molecule to the surface giving the substrate a low energy surface from what was originally a high energy surface.

In some embodiments, the impervious coating may be disposed on any portion, up to the entirety, of the substrate surface. In some embodiments, the impervious coating may be disposed directly on the surface. In some embodiments, the impervious coating may have a thickness (i.e., dimension of the impervious coating in a direction that is normal to a major surface) of between 0.1 nm and 20 nm or between 0.5 nm and 5 nm. In one preferred embodiment, the impervious coating may be disposed as a monolayer on the surface, such that the phosphate groups are bonded to said surface. In at least one preferred embodiment, the impervious coating has a substantially uniform thickness. In at least some embodiments, the impervious coating has a uniform thickness regardless of whether the substrate is smooth or textured.

In some embodiments, once the impervious coating is deposited it is heat treated. Suitable methods of heat treatment include subjecting the impervious coating to a heat lamp or heat gun at temperatures of about 45 to 100° C. for any suitable amount of time including 5 seconds to 15 minutes.

In some embodiments, the fluorinated polymer may be deposited in the form of a solution that includes a solvent and the fluorinated polymer. Suitable solvents include fluorinated fluids, such as hydrofluoroethers. Suitable deposition techniques for the fluorinated polymer (or solvent containing the fluorinated polymer) include physical or chemical vapor deposition, spray coating, dip coating, wipe coating, spin coating, or other known material deposition processes. Following deposition of the fluorinated material, optionally, any remaining solvent may be removed from the substrate.

In some embodiments of the present disclosure, the fluorinated polymer of the impervious coating when bonded to a metal, metal oxide, or silicon dioxide provides extremely low surface energy with substantial durability.

The impervious coating can be effectively used to make various articles resistant to graffiti. Such articles can repel materials used to create graffiti, such as paint and ink. The impervious coating also can make it easier to remove such materials if any are deposited on the article surface.

The operation of the present disclosure will be further described with regard to the following detailed examples. These examples are offered to further illustrate various specific embodiments and techniques. It should be understood, however, that many variations and modifications may be made while remaining within the scope of the present disclosure.

### Examples

All materials are commercially available, for example from Sigma-Aldrich Chemical Company, Milwaukee, Wis., USA, or known to those skilled in the art, unless otherwise stated or apparent.

The following abbreviations are used in this section: mL=milliliters, g=grams, kg=kilograms, cm=centimeters, dm=decimeters, μm=micrometers, mil=thousandths of an inch, wt %=percent by weight, sec=seconds, min=minutes, h=hours, d=days, N=Newtons, NMR=nuclear magnetic resonance, eq=equivalent, mmoles=millimoles, ° C.=degrees Celsius, ° F.=degrees Fahrenheit, % T=percent transmission. Abbreviations for materials used in this section, as well as descriptions of the materials, are provided in Table 1.

TABLE 1

| Material | Details |
|---|---|
| 11-Bromo-1- | Available from Sigma Aldrich |
| undecanol | |
| DMF | Dimethylformamide, available from Sigma |
| | Aldrich |
| Potassium | Available from Sigma Aldrich |
| phthalimide | |
| Ethyl acetate | Available from Sigma Aldrich |
| Hydrobromic acid | 45 wt % in acetic acid, available from VWR, |
| | Radnor, PA, USA |
| Sulfuric acid | 96 wt %, available from Sigma Aldrich |
| Heptane | Available from Sigma Aldrich |
| Triethyl phosphite | Available from Sigma Aldrich |
| Ethanol | Available from Sigma Aldrich |
| Hydrazine hydrate | Available from Sigma Aldrich |
| Acetone | Available from Sigma Aldrich |
| HFE-7200 | Ethoxy-nonafluorobutane, 99.0% minimum, |
| | available under the trade designation 3M |
| | NOVEC 7200 Engineered Fluid from 3M Company |
| Methanol | Available from Sigma Aldrich |
| Trimethylsilyl | Available from Sigma Aldrich |
| bromide | |
| Ethanolamine | Available from Sigma Aldrich |
| Triethylamine | Available from Sigma Aldrich |
| Phosphorus | Available from Sigma Aldrich |
| oxychloride | |
| Magnesium sulfate | Available from Sigma Aldrich |
| Acetic Acid | Available from Fisher Scientific |
| Hydrochloric Acid | Available from Fisher Scientific |
| (37 wt % Solution) | |
| IPA | Isopropyl alcohol, available from Fisher |
| | Scientific |
| CELITE R566 | A type of diatomaceous earth, Available from |
| | Sigma Aldrich |
| Silica Gel | Available from Millipore Sigma |
| THF | Tetrahydrofuran, available from Fisher Scientific |
| Hexanes | Available from Fisher Scientific |
| HFE- 7300 | (1,1,1,2,2,3,4,5,5,5-decafluoro-3-methoxy-4- |
| | (trifluoromethyl)-Pentane), available under |
| | the trade designation 3M NOVEC 7300 Engineered |
| | Fluid from 3M Company |

### Precursor 1—Preparation of 2-(11-Hydroxyundecyl)isoindoline-1,3-dione

To a mixture of 100.0 g (398 mmoles, 1 eq) of 11-bromoundecanol in 1000 mLs of DMF was added 111 g (597 mmoles, 1.5 eq) of potassium phthalimide. The mixture was heated to 65° C. for 16 hours. To the reaction mixture was added 200 mL of water. The mixture became homogeneous and exothermed to 37° C. To this mixture at 37° C. was added an additional 1000 g of water. This caused the product to precipitate. The mixture got very viscous and agitation was increased to allow for good mixing. The mixture was then allowed to cool to room temperature. The mixture was filtered and the residue was washed with 2 L of water five times. This crude product was air dried to give 75.7 grams, a 60% yield.

### Precursor 2—Preparation of 2-(11-Bromoundecyl)isoindole-1,3-dione

A solution of 106 g (334 mmoles, 1 eq) of Precursor 1 in 600 g of a 45 wt % solution (3340 mmoles, 10 eq) of hydrobromic acid in acetic acid was prepared and 27.8 mLs of an 18 M solution (501 mmoles, 1.5 eq) of sulfuric acid (18 M, 96 wt. %) was added. This caused a slight exotherm but the reaction temperature was allowed to increase without external cooling. The reaction was then heated to 100° C. for 4 hours. The mixture was allowed to cool to room temperature. To the reaction mixture was added 550 g of water. This gave a slight exotherm and the mixture was allowed to cool and a precipitate formed. The mixture was stirred overnight and the precipitate was collected by filtration, and the solid was then washed with 8 L of water until the pH of the water phase become greater than 1. This was triturated with 320 g of heptane and air dried to give 110.7 grams of the product.

### Precursor 3—Preparation of Diethyl (11-(1,3-Dioxoisoindolin-2-yl)undecyl)phosphonate

To 110 g (289 mmoles, 1 eq) of Precursor 2 was added 115 g (694 mmoles, 2.4 eq) of triethyl phosphite. The reaction was slightly endothermic. The mixture was heated to 150° C. for 18 hours. A vacuum (approximately 1 torr) was applied and the diethyl ethylphosphonate by-product was stripped off. The pot residue yielded 126 grams of the product.

### Precursor 4—Preparation of Diethyl (11-Aminoundecyl)phosphonate

To a solution of 126 g (288 mmoles, 1 eq) of Precursor 3 in 720 mLs of ethanol was added 23.1 g (461 mmoles, 1.6 eq) of hydrazine hydrate. This mixture was heated to 78° C. for 1.5 hours and a solid precipitated. The mixture was filtered and the residue was washed with ethanol. The combined filtrates (approximately 2 L) was concentrated. The residue was treated with 200 mL of acetone. A white solid precipitated and was washed with water. The solid was discarded. The combined dark brown filtrate and water wash was concentrated on a roto-evaporator. To the concentrate was added 200 mL of acetone. A white solid precipitated and was washed with water. The solid was discarded. The combined dark brown filtrate and water wash was concentrated on a roto-evaporator. The concentrate gave the desired product.

### Precursor 5—Preparation of 7K HFPO Methyl Ester

A mixture of 1512 g (216.0 mmoles, 1 eq) of KRYTOX 157 FS (H), 1289 g (3681 mmoles, 17.0406 eq) of HFE-7300, and 120.1 g (945.9 mmoles, 4.379 eq) of oxalyl chloride was heated 65° C.-70° C. (reflux oxalyl chloride). The mixture was heated for 3 hours and then to 85° C. for one hour. The mixture was then heated to 100° C. to distill off the oxalyl chloride. The head temperature started at 65° C. and gradually rose to 97° C. The pot temperature rose to 102° C. to give 25 grams of distillate. The reaction temperature was cooled to 50° C. and 316.4 g (9874 mmoles, 45.7152 eq) of methanol was added. The mixture gave a mild exotherm and was then stirred overnight. The reaction mixture was phase split and the bottom (fluorochemical phase) was collected. The fluorochemical phase was distilled to removed residual methanol and some of the HFE-7300 (100 grams of the distillate was collected with a final distillate temperature of 95° C.).

### Precursor 6—Preparation of Second HFPO Methyl Ester

Prepared in the same manner as Precursor 5 except that HFPO carboxylic acid 1250 Mwt was used instead of KRYTOX 157 FS (H).

### Precursor 7—Preparation of Diethyl (11-HFPO-Amidoundecylphosphonate) MWt. 1250.)

A mixture of 10.0 g (7.67 mmoles, 1 eq) of Precursor 6 and 2.39 g of (7.78 mmoles, 1.01 eq) of Precursor 4 was stirred at 75° C. for 18 hours to give the desired product.

### Precursor 8—Preparation of HFPO-Alcohol 7K

The HFPO-alcohol 7K was prepared in the same manner as described in Olson et al., US2018/0030285, paragraphs [0032]-[0033].

### Precursor 9—Preparation of Methyl Esters of HFPO

The methyl esters of HFPO were prepared in the same manner as described EP 0 154 297 (“Purification and polymerization of hexafluoropropylene oxide”), Example 2, page 13, line 25-page 15, line 25.

### Precursor 10—Preparation of HFPO-Alcohol 19K

To a 1000 ml 3 neck jacketed cylindrical flask equipped with overhead stir was added 3.7830 g (0.10000 moles, 4 eq) of Sodium borohydride, 45.385 g of THF. After 15 min in the ice bath the mixture was treated with 300.00 g (0.025000 moles, 1 eq) of Precursor 9 dissolved in 600.00 g of HFE-7300. The temp rose to 5° C. and gas was evolving. When the temp was at 1° C. the mixture was treated with 3.2040 g (0.10000 moles, 4 eq) of methanol. 30 min later it was treated with 3.2040 g (0.10000 moles, 4 eq) of methanol. 60 min later it was treated with 3.2040 gs (0.10000 moles, 4 eq) of methanol. 120 min later it was treated with 3.2040 g (0.10000 moles, 4 eq) of methanol. The mixture was stirred overnight at room temp. A 10 ml in-process sample was taken and treated with 1 ml methanol, then 5 ml 1N HCl. It was phase split and submitted for QCM. The remaining mixture was treated with 13.010 g (0.40605 moles, 16.2421 eq) of methanol, followed by 18.555 g (0.30898 moles, 12.3593 eq) of acetic acid. After 10 min it was treated with 147.85 g (8.2069 moles, 328.277 eq) of water, then stirred for 30 min and phase split. The top aqueous phase was removed and the remainder was washed with 25 ml methanol. The mixture was then phase split to remove the top organic phase. The fluorocarbon layer was stripped at 50° C. and full vacuum (15 torr final vacuum) to recover an opaque oil.

### Precursor 11—Preparation of 11-(nonafluorobutyl)-1-undecanol

The 11-(nonafluorobutyl)-1-undecanol was prepared in the same manner as described in Boardman et al., U.S. Pat. No. 6,824,882, Example 2, col. 9, line 8-col. 10, line 2.

### Example 1—Preparation of 11-HFPO-Amidoundecylphosphonic Acid MWt. 1250

To a mixture of 5.00 g (3.14 mmoles, 1 eq) of Precursor 7 and 7.54 g of acetic acid was added 24.7 g of a 37 wt % solution of hydrochloric acid. This mixture was heated to 95° C. for 18 hours. The reaction mixture was cooled and a soft brown semi-solid material was isolated by filtration and washed with water. The isolate was allowed to air dry for 3 days.

### Example 2—Preparation of 11-HFPO-Amidoundecylphosphonic Acid MWt. 7K HFPO

To a mixture of 6.00 g (1.00 mmoles, 1 eq) of Precursor 5 was added 0.622 grams (2.0 mmoles, 2 eq) of Precursor 4. The mixture was heated to 100° C. for 18 hours. The reaction mixture was cooled to 40° C. and 5 ML of HFE-7200 was added followed by 1.53 g (10.0 mmoles, 10 eq) of trimethylsilyl bromide. The mixture was heated to 40° C. for 6 hours and then cooled, and 5 mL of methanol was added. The mixture was phase split and the bottom phase was concentrated in vacuo, at 10 torr and 50° C., for several hours. This yielded 2.39 grams of product.

### Example 3—Preparation of HFPO-Phosphate Ester MWt. 7K

To a mixture of 0.256 g (1.67 mmoles, 2 eq) of phosphorus oxychloride in 5.00 mLs of HFE-7200, cooled with an ice bath, was added 15.0 g of a 33.3 wt % solution (0.8333 mmoles, 1 eq) of Precursor 8, 33.3 wt % in HFE-7200. To this was added 0.169 g (1.67 mmoles, 2 eq) of triethylamine. This mixture was stirred for 2 hours at room temperature and then quenched with 5.00 g of water and stirred overnight. More water was added followed by 100 g of HFE-7200, followed by 50 mL of IPA. The mixture was phase-separated, and the organic phase was washed with more water. This was a slow phase split. The organic phase was concentrated in vacuo to yield the product.

### Example 4—Preparation of HFPO-Amidol Phosphate Ester MWt. 7K

A mixture of 6.00 g (1.00 mmoles, 1 eq) of Precursor 5 and 0.122 g (2.00 mmoles, 2 eq) of ethanolamine was heated to 100° C. for 24 hours. This mixture was cooled to 40° C. and 0.202 g (2.00 mmoles, 2 eq) of triethylamine was added, followed by 0.307 g (2.00 mmoles, 2 eq) of phosphorus oxychloride. The mixture was maintained at 40° C. for 2 hours. To the reaction mixture was added 4 mL of water and the mixture was heated to 55° C. and maintained overnight. To this mixture was added 30 mL of HFE-7200 followed by 30 mL of a saturated aqueous solution of sodium chloride. The mixture was phase-split and the bottom layer was washed a second time with water, then dried with magnesium sulfate, and concentrated to yield the product.

### Example 5—Preparation of HFPO-Phosphate Ester MWt. 20K

To a mixture of 0.0968 g (0.632 mmoles, 2 eq) of phosphorus oxychloride in 5.00 mLs of HFE-7200, cooled with an ice bath, was added a mixture of 6.00 g (0.316 mmoles, 1 eq) of Precursor 9 in 20.0 mLs of HFE-7200 followed by 0.0639 g (0.632 mmoles, 2 eq) of triethylamine. This mixture was stirred for 2 hours at room temperature and then quenched with 5.00 g of water. The reaction mixture was passed through a filter with CELITE R566 and 20 grams of silica gel. The filtrate was dissolved in additional HFE-7200 to give approximately 62 wt % HFPO-PE 20K in HFE-7200.

### Comparative Example 6—Preparation of 1-phosphono-11-(nonafluorobutyl)undecane

To a solution of 199.7 g of perfluorobutyl iodide and 93.7 g of 10-undecen-1-ol in a mixture of 700 mL of acetonitrile and 300 mL of water, was added a mixture of 53.8 g of sodium bicarbonate and 106.2 g of sodium dithionite in small increments with stirring. The reaction mixture was stirred at room temperature overnight and acidified with 1N hydrochloric acid. The mixture was extracted with diethyl ether, and the combined organic phases were sequentially washed with saturated aqueous sodium bicarbonate and a saturated aqueous solution of sodium chloride, then dried over anhydrous magnesium sulfate. Concentration of the ether solution afforded 234.4 g of crude 10-iodo-11-(nonafluorobutyl)-1-undecanol as a viscous, light amber liquid, which was used without further purification.

To a slurry of 130.0 g of zinc powder in 500 mL of ethanol was added 5.0 g of acetic acid. A solution of 230.0 g of the crude 10-iodo-11-(nonafluorobutyl)-1-undecanol prepared above in 100 mL of ethanol was added dropwise with stirring over 1 hr. Then, the reaction mixture was heated at 50° C. for 4 hr. The mixture was filtered, and the filtrate was concentrated to a viscous, light yellow liquid. Bulb-to-bulb distillation of the liquid, in several portions, provided 97.3 g of 11-(nonafluorobutyl)-1-undecanol as a colorless solid, having a boiling point (b.p.) of 160-200° C. at 0.05 torr (7 Pa).

To a mixture of 19.52 g of the 11-(nonafluorobutyl)-1-undecanol prepared above and 200 mL of 48 weight percent hydrobromic acid was slowly added 20 mL of concentrated sulfuric acid. The reaction mixture was heated at 100° C. for 24 hr and poured into 1 liter of water. The mixture was extracted with hexanes, and the combined organic phases were washed with saturated aqueous sodium bicarbonate and dried over anhydrous magnesium sulfate. The solution was concentrated to an amber liquid, which was eluted through 3 inches of silica with hexanes. Concentration of the eluent yielded a light amber liquid, and bulb-to-bulb distillation gave 19.82 g of 1-bromo-1-(nonafluorobutyl)undecane as a clear, colorless liquid, b.p. 120-170° C. at 0.06 torr (8 Pa).

A mixture of 15.03 g of the 1-bromo-11-(nonafluorobutyl)undecane prepared above and 15.00 g of triethyl phosphite was heated at 150° C. After 18 hr, an additional 9.00 g of triethyl phosphite was added, and heating was continued for 24 hr. Diethyl ethylphosphonate and other volatiles were removed by distillation, b.p. 30-50° C. at 0.05 torr (7 Pa). Bulb-to-bulb distillation of the concentrate provided 16.07 g of 1-(diethylphosphono)-1-(nonafluorobutyl)undecane as a clear, colorless liquid, b.p. 170-200° C. at 0.05 torr (7 Pa).

To a solution of 15.23 g of the 1-(diethylphosphono)-11-(nonafluorobutyl)undecane prepared above in 40 mL of dichloromethane was added 11.50 g of bromotrimethylsilane. After 24 hr at room temperature, the solution was concentrated to a pale yellowish liquid, and the intermediate silylphosphonate ester was dissolved in 200 mL of methanol. The resultant solution was stirred at room temperature for 30 min and concentrated to a white solid. Dissolution in methanol and concentration were repeated two times, and two recrystallizations of the crude product from heptane gave 10.85 g of 1-phosphono-11-(nonafluorobutyl)undecane (CF3(CF2)3(CH2)11PO3H2) as colorless plates, with a melting point of 93-96° C.

### Comparative Example 7—Preparation of 11-(nonafluorobutyl)undecyl Dihydrogen Phosphate

To a mixture of 0.786 g (5.12 mmoles, 2 eq) of phosphorus oxychloride in 0.94 mLs of THF, cooled with an ice bath, was added a mixture of 1.00 g (2.56 mmoles, 1 eq) of Precursor 11 in 2.50 mLs of THF. This mixture was stirred for 1 hour. To this mixture was added 0.519 g (5.12 mmoles, 2 eq) of triethylamine. This mixture was stirred for 3 hours and quenched with water. The mixture was stirred for about 1 hour and then treated with 10 mL of ethyl acetate. The mixture was phase-split and the organic layer was washed twice with water and then concentrated in vacuo. The residue was recrystallized with approximately 5 mL of hexanes to yield the product.

### Application of Impervious Coating (Including Surface Cleaning)

2″×6″ aluminum coupons were sanded with 400 grit sandpaper and then washed with DI water while further cleaning the surface with SCOTHC BRITE Green Heavy Duty Scouring Hand Pads. The aluminum coupons were rinsed with IPA and allowed to dry. Half of each coupon was treated with the impervious coating by application with polyurethane foam brushes, and any excess was rinsed off with IPA. The treated coupon specimens were allowed to dry.

### Imperviousness and Acid Stability

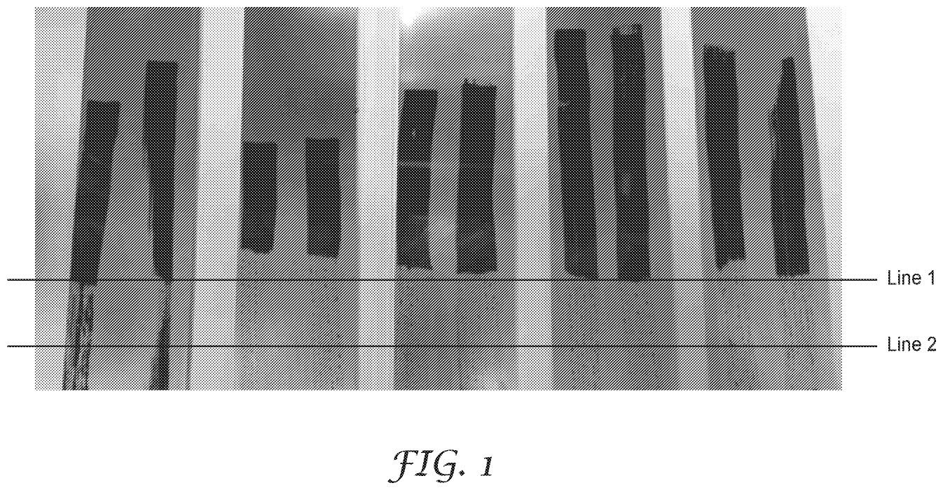

As indicated in FIGS. 1 (Examples 1-5) and 2 (CE 6 and CE7), the portions of coupon below Line 1 were treated with the impervious coating, then the portion below Line 2 was soaked in acetic acid for 18 hours, after which the specimen was marked along the entire length of the coupon with a SHARPIE pen having a wide tip. The quality of the mark left by the marking pen was visually assessed. The qualitative results are described in Table 2 below.

TABLE 2

| | | | Area treated with |
|---|---|---|---|
| | | | impervious coating |
| | Untreated | Area treated with | and soaked in acetic |
| Example | area | impervious coating | acid for 18 hours |
| 1 | continual | streaking | Streaking and continual |
| 2 | continual | beading | Beading and streaking |
| 3 | continual | beading | beading |
| 4 | continual | beading | beading |
| 5 | continual | beading | Beading and streaking |
| C6 | continual | continual and streaking | N/A |
| C7 | continual | continual | N/A |

### Peel Test

Two strips of Scotch™ Magic Tape 810 available from 3M Company, St. Paul, Minn. were applied along the length of each test coupon, covering both the untreated and treated sections of the coupons, and secured using a 4 lb roller. The taped test specimens were allowed to dwell for two days and then subjected to tape peels (180 degree) using a peel tester (available from IMass Inc. Accord, Mass.). A total of six peels were made for each strip of tape. The initial peel (approximately ½″) was made on one of the tape strips on the untreated portion of the coupon. The instrument was reset and a second ½″ peel was made on the same strip of tape on the untreated portion. The instrument was reset and a third ½″ peel was made on the untreated portion. This process was then repeated on the treated half of the coupon. This procedure was then repeated on the second strip of tape on the test coupon to give a total of six data points for each untreated and treated portion of the test coupon. Table 3 below shows the averages of each set of six data points. The peel force needed for removal of a tape strip from the treated aluminum surface can also be expressed as a percentage of the peel force needed to remove the tape strip from the bare (untreated) aluminum surface, and this value is recorded as the Remaining Peel Force, in %.

TABLE 3

| | Bare Al | | Treated | | Remaining |
|---|---|---|---|---|---|
| | ounce- | StdDev | ounce- | StdDev | Peel |
| Example | force | (+/−) | force | (+/−) | Force |
| 1 | 21.6 | 2.5 | 2.3 | 0.2 | 11% |
| 2 | 23.0 | 2.2 | 0.4 | 0.1 | 2% |
| 3 | 21.7 | 2.4 | 0.3 | 0.1 | 1% |
| 4 | 23.0 | 2.4 | 0.4 | 0.1 | 2% |
| 5 | 23.2 | 2.0 | 0.9 | 0.3 | 4% |
| C6 | 22.5 | 2.0 | 7.2 | 0.8 | 32% |
| C7 | 22.8 | 2.5 | 8.5 | 0.8 | 37% |

Foreseeable modifications and alterations of this invention will be apparent to those skilled in the art without departing from the scope and spirit of this invention. This invention should not be restricted to the embodiments that are set forth in this application for illustrative purposes.

1. A graffiti-repellant article comprising:
a substrate having a surface comprising metal, metal oxide, silicon oxide, or combinations thereof; and
an impervious coating disposed on said surface, wherein the impervious coating comprises a fluorinated polymer bonded to the surface layer;
wherein the fluorinated polymer has the following general formula (I) 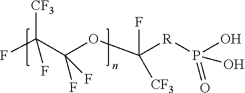
where n=6 to 120.

2. The graffiti-repellant article of claim 1 wherein the substrate is flexible.

3. The graffiti-repellant article of claim 1 wherein the substrate is rigid.

4. The graffiti-repellant article of claim 1 wherein the surface of the substrate is the same material as the bulk of the substrate

5. The graffiti-repellant article of claim 1 wherein the surface of the substrate is a layer of material different from an adjacent material of substrate.

6. The graffiti-repellant article of claim 5 wherein the thickness of the surface layer is a monolayer to about 20 microns.

7. The graffiti-repellant article of claim 1 wherein the surface is selected from the group consisting of aluminum, titanium, nickel, chromium, chromium-containing alloys, aluminum oxide, chromium oxide, nickel oxides, titanium oxide, tungsten oxides, silicon oxide, and combinations thereof.

8. The graffiti-repellant article of claim 1 wherein the mean average thickness per unit area of the impervious coating is about 1 molecule thick.

9. The graffiti-repellant article of claim 1 wherein the substrate has a surface roughness (Ra) of at most 0.1 micrometers.

10. The graffiti-repellant article of claim 1 wherein the substrate has a surface roughness (Ra) of at least 10 micrometers.

11. The graffiti-repellant article of claim 1, wherein the fluorinated polymer includes polymers for which n=36 to 42.

12. The graffiti-repellant article of claim 1, wherein the fluorinated polymer has the following formula: 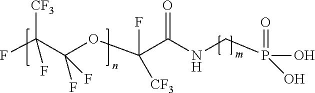
where n=6 to 120 and
m=1 to 25

13. The graffiti-repellant article of claim 1, wherein the fluorinated polymer has the following formula: 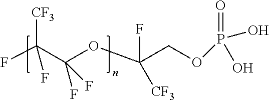
where n=6 to 120.

14. The graffiti-repellant article of claim 1, wherein the fluorinated polymer has the following formula: 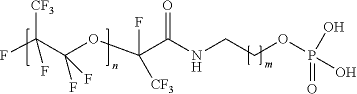
where n=6 to 120 and
m=1 to 25.

15. The graffiti-repellant article of claim 1, wherein the impervious coating has been heat treated.

16-17. (canceled)
